(19) United States
(12) Patent Application Publication
(10) Pub. No.: US 2017/0145716 A1
(43) Pub. Date: May 25, 2017

(54) DOOR LATCH ASSEMBLY

(71) Applicant: Janus International Group LLC, Temple, GA (US)

(72) Inventors: Gerard RYAN, Brisbane (AU); Jonathan PERRINS, Brisbane (AU); Joshua WILLOUGHBY, Brisbane (AU); Mark SANDSTROM, Brisbane (AU)

(21) Appl. No.: 15/423,146

(22) Filed: Feb. 2, 2017

Related U.S. Application Data
(63) Continuation of application No. PCT/AU2014/000780, filed on Aug. 4, 2014.

(51) Int. Cl. E05B 65/00; E06B 9/08; E05B 15/16; E05C 1/10; E05B 9/08

(52) U.S. Cl. CPC E05B 65/0021; E05C 1/10; E05B 9/08; E05B 15/1635; E06B 9/08

(57) ABSTRACT

The present invention is directed to a door latch assembly for a roller door that has a plastic mounting plate and a latching plate and latch tongue positioned substantially within the mounting plate. The use of a plastic mounting plate avoids the problems of corrosion when two different metal surfaces are fixed to each other.

### CROSS-REFERENCE TO RELATED APPLICATIONS

This application is a continuation of International Application No. PCT/AU2014/000780, filed Aug. 4, 2014. The above-referenced patent application is incorporated by reference in its entirety.

### BACKGROUND OF THE INVENTION

Field of the Invention

The present invention relates to a door latch assembly with particular but not exclusive application for latching a roller door.

Description of the Related Technology

Latches are used on roller doors for security purposes. Because of the profile of the roller doors with a corrugated surface of ridges and grooves the selection and placement of latches is limited. The fixing of metal latches to the metal corrugated surface of roller doors leads in time to corrosion around the area of the fixed latch. The corrosion degrades the metal and results in weaknesses metal surfaces and eventually produces holes about the area of the latch leaving the door irreparably damaged. In this state, the roller door cannot be secured and the resultant holes expose the contents behind the roller door to the weather such as rain. When the roller door is irreparably damaged, the roller door can only be replaced.

Corrosion between two metal surfaces is accelerated in the presence of moisture particularly if it collects in already damaged areas. Rain and other weather contribute to increasing the rate of corrosion when the roller doors are outdoors. Corrosion is a constant problem with roller doors and latches.

### OBJECT OF THE INVENTION

It is an object of the invention to provide a door latch assembly for a roller door which overcomes or at least partly ameliorates some of the abovementioned disadvantages of current roller door latches.

### SUMMARY

The invention was developed from continuous trial and error and refining dimensions of components to produce a door latch assembly that substantially prevents corrosion of the metal surface of a roller door.

In one aspect the present invention broadly resides in a door latch assembly for a roller door, said roller door having a corrugated surface of ridges and grooves; the door latch assembly including a latching member attachable to the door, a non-metal means separating the latching member from the door when the latching member is installed; a latch tongue operatively retained by the mounting means and movable between a retracted position and an extended position for engagement with a door jamb, the latch tongue has at least one protruding portion; wherein the assembled door latch assembly has the latching member located substantially therein and the at least one protrusion of the latch tongue extends outwardly through the mounting means and the latching member to provide access to the latch tongue; the non-metal mounting means is attached to the roller door when the assembled door latch assembly is in use.

In another aspect the present invention broadly resides in a door latch assembly for a roller door, said roller door having a corrugated surface of ridges and grooves; the door latch assembly including a latching member attachable to the door, said latching member has a non-metal coating or layer on a surface that is positioned adjacent the door when installed; a latch tongue operatively retained by the mounting means and movable between a retracted position and an extended position for engagement with a door jamb, the latch tongue has at least one protruding portion; wherein the assembled door latch assembly has the latching member located substantially therein and the at least one protrusion of the latch tongue extends outwardly through the mounting means and the latching member to provide access to the latch tongue; the non-metal mounting means is attached to the roller door when the assembled door latch assembly is in use.

In another aspect the present invention broadly resides in a door latch assembly for a roller door, said roller door having a corrugated surface of ridges and grooves; the door latch assembly including a non-metal mounting means attachable to the door; a latching member locatable substantially within the mounting means; a latch tongue operatively retained by the mounting means and movable between a retracted position and an extended position for engagement with a door jamb, the latch tongue has at least one protruding portion; wherein the assembled door latch assembly has the latching member located substantially therein and the at least one protrusion of the latch tongue extends outwardly through the mounting means and the latching member to provide access to the latch tongue; the non-metal mounting means is attached to the roller door when the assembled door latch assembly is in use.

Preferably the mounting means is attachable substantially within the groove of a corrugation of the door. Preferably the door latch assembly is attachable substantially within the groove of a corrugation of the door. In another embodiment the door latch assembly is positionable over a ridge between two grooves of a corrugation of the door. Preferably the installed door latch assembly is substantially recessed. More preferably the installed door latch assembly does not extend outwardly substantially beyond the ridges of the door corrugations. The mounting means is preferably spaced from the roller door surface to allow the circulation of air to dry the surface. The mounting means preferably has a plurality of spacers separating the mounting means from the roller door surface. The mounting means is preferably made of plastics. The mounting means is more preferably made of UV stabilized plastics for use in outdoor areas. The mounting means preferably includes a mounting plate having a recess to accommodate the latching member. The mounting means in another embodiment includes a mounting plate and latching tongue backing plate.

The at least one protrusion preferably forms a handle that can be used by a person to move the latching tongue. The at least one protrusion in one embodiment can form a handle and a locking configuration. In an alternate embodiment there are at least two protrusions where one forms a handle while the other forms part of a locking configuration. Preferably, the latching member comprises at least one retaining arrangement for retaining the latching member to the latch tongue. Preferably, the retaining arrangement is configured for retaining the door latch assembly to the roller door at a location substantially intermediate the width of the groove. Preferably, the retaining arrangement retains both the latching member and the latch tongue to the roller door.

In one alternative embodiment, the securing arrangement is configured to retain the latching member to the latch tongue, and in turn retain the latch tongue to the roller door. Preferably the retaining arrangement includes two or more fasteners. Preferably, the fasteners can be rivets, screws, or a bolt and nut arrangement.

Preferably, the latching member comprises a locking arrangement configured for locking the latch tongue in its extended position. Preferably, the locking arrangement comprises a first locking formation coupled to the latch tongue, and a complementarily configured second locking formation securely associated with the latching member, the first locking formation and the second locking formation being complementarily configured to be locked together by a padlock when the latch tongue is in one position selected from its extended position and its retracted position. Preferably, the first locking formation and the second locking formation each comprise apertures that align when the latch tongue is in its extended position. With this embodiment a separate padlock type lock is preferably used to the first locking formation with the second locking formation.

In another preferred embodiment, the locking arrangement comprises lock engaging formations configured for engaging and locating a lock barrel. Preferably, the locking arrangement comprises a lock barrel. Preferably, the lock barrel comprises one or more biased lock members. Preferably, the bias is a spring. Preferably, the lock barrel is movable between a locked position and an unlocked position. Preferably, the lock barrel is configured to be spring biased to move to its locked position and comprises latching means for holding the lock barrel in its locked position, and wherein the lock barrel is only moveable towards its unlocked position on operation of a key on the key barrel. Preferably, the lock tongue comprises one or more selected from an aperture and a recess for receiving at least part of the lock barrel.

The door latch assembly can also include an over-locking or secondary locking arrangement. In one form the secondary locking arrangement includes a second set of overlapping apertures associated with the latching member and the latch tongue where a separate padlock type lock can be used to the door latch assembly in the latch tongue's extended position. In an alternate form an insert positionable within the latching member and serving to prevent retraction of the latch tongue can be located and locked in position to the latching member. Preferably, the latch tongue is slidably moveable between its extended position and its retracted position.

In one embodiment, at least one or more of the latch tongues is comprised of resilient material. In one embodiment, at least one or more of the latch tongues is comprised of plastic. Preferably, the base plate is configured for guiding sliding movement of the latch tongue. Preferably, the base plate is configured for guiding sliding movement of the latch tongue by means of a guiding arrangement. Preferably the non-metal mounting means can be of different sizes to substantially fit within corresponding sized recesses in different corrugations while all able to accommodate the same latching member.

In a further aspect, the invention broadly resides in a system for a door latch assembly for a roller door, comprising a non-metal mounting means selected from a plurality of different sized non-metal mounting means where each fits substantially within a groove of a particular corrugated profile; a latching member positionable within the non-metal mounting means; and a securing arrangement for securing the latching member and latch tongue substantially within the groove of the roller door.

In another aspect, the invention resides broadly in a method of installing a door latch assembly on a roller door having a corrugated profile of grooves and ridges, the method comprising the steps of selecting a non-metal mounting means from a plurality of non-metal mounting means s having alternative profiles for engaging roller doors of varying profiles, the selected non-metal mounting means having a profile adapted for snug engagement substantially within a groove of the roller door to which the door latch assembly is to be installed; locating a latching member into snug abutment with the selected non-metal mounting means; and securing the latching member and latch tongue substantially within the groove of the roller door. In another aspect the present invention comprises a kit for a door latch assembly for a roller door, the roller door including a corrugated surface of ridges and grooves, the kit comprising: a non-metal mounting means; a latch tongue movable between an extended position and a retracted position, and a handle member for moving the latch tongue between its extended and retracted positions; and a latching member configured and adapted for being received within a groove of a corrugated roller door. Preferably, the non-metal mounting means comprises door engaging formations configured for engaging snugly against the groove of the roller door in use.

In another aspect, the present invention comprises a roller door assembly comprising a corrugated roller door having a series of alternating grooves and ridges on at least one major face; and a door latch assembly as described above mounted substantially within a groove of the roller door. Preferably, the door latch assembly is mounted within the groove of the roller door. Preferably, the door latch assembly is secured within the groove of the roller door at a location substantially intermediate the width of the groove.

The features described with one aspect apply also to other aspects of the invention where applicable. Furthermore different combinations of features are claimed and described even if not explicitly stated.

### BRIEF DESCRIPTION OF THE DRAWINGS

In order that the present invention can be more readily understood reference will now be made to the accompanying drawings which illustrate different preferred embodiments of the invention and wherein:

FIG. 1 is a rear isometric view of a first embodiment of a door latch assembly for use with a key barrel with its latch tongue in an extended position;

FIG. 2 is a front isometric view of the door latch assembly of FIG. 1 with its latch tongue in an extended position;

FIG. 3 is a rear isometric view of the door latch assembly of FIG. 1 with its latch tongue in a retracted position;

FIG. 4 is a front isometric view of the door latch assembly of FIG. 1 with its latch tongue in a retracted position;

FIG. 5 is a rear isometric view of a second embodiment of a door latch assembly for use with a padlock with its latch tongue in an extended position;

FIG. 6 is a front isometric view of the door latch assembly of FIG. 5 with its latch tongue in an extended position;

FIG. 7 is a rear isometric view of the door latch assembly of FIG. 5 with its latch tongue in a retracted position;

FIG. 8 is a front isometric view of the door latch assembly of FIG. 5 with its latch tongue in a retracted position;

FIG. 9 is a rear isometric assembly view of a door latch assembly with an alternative latch tongue;

FIG. 10 is a rear isometric assembly view of the first embodiment of a door latch assembly shown in FIG. 1;

FIG. 11 is a side view of a door latch assembly of FIG. 1 installed on a corrugated roller door;

FIG. 12 is an exploded view of the first embodiment of a door latch assembly shown in FIG. 1;

FIG. 13 is an exploded view of the second embodiment of a door latch assembly shown in FIG. 5; and

FIGS. 14 and 15 are diagrammatic views of a locking insert to provide a second locking arrangement for the door latch assembly shown in FIG. 1.

### DETAILED DESCRIPTION OF CERTAIN INVENTIVE EMBODIMENTS

With reference to the above Figures, in which similar features are generally indicated by similar numerals.

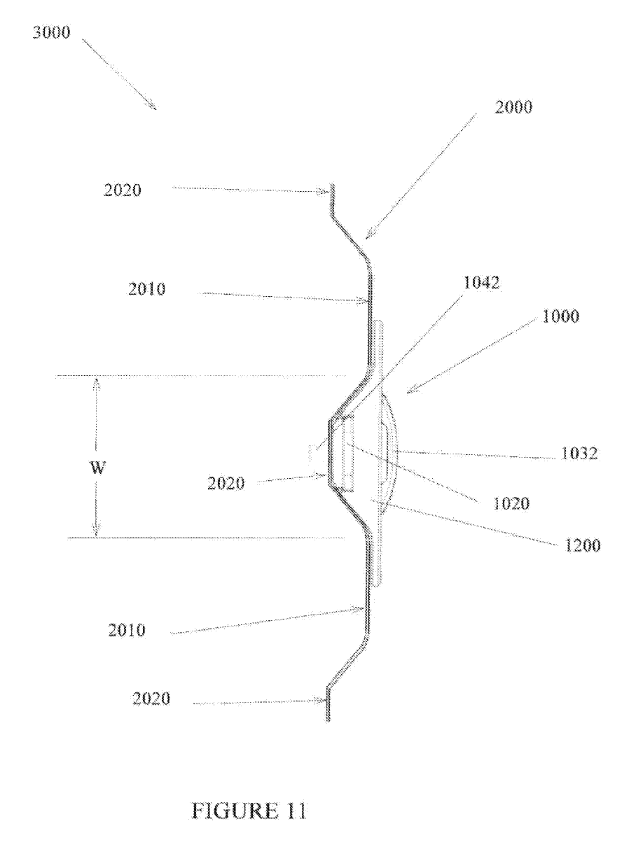

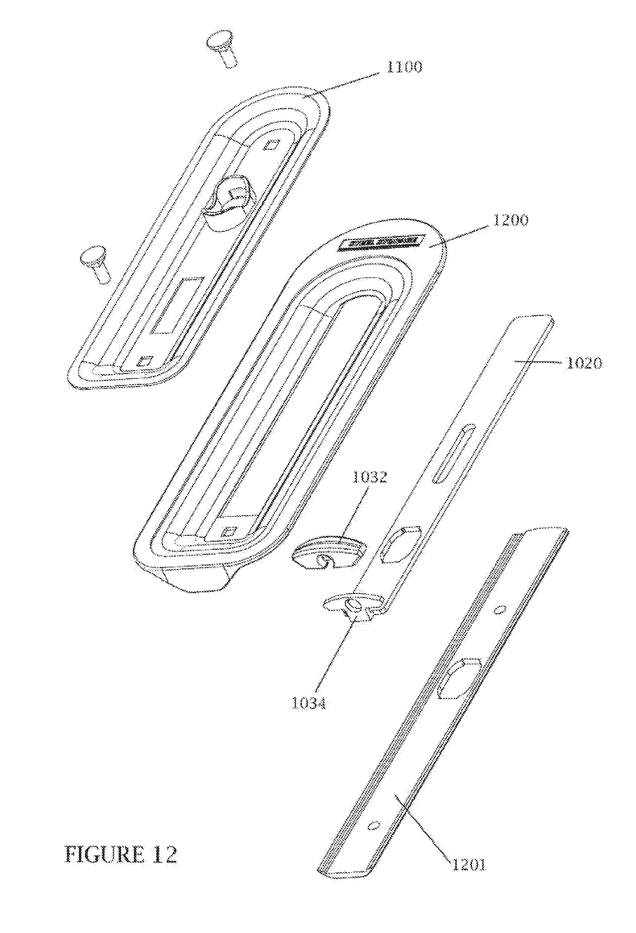

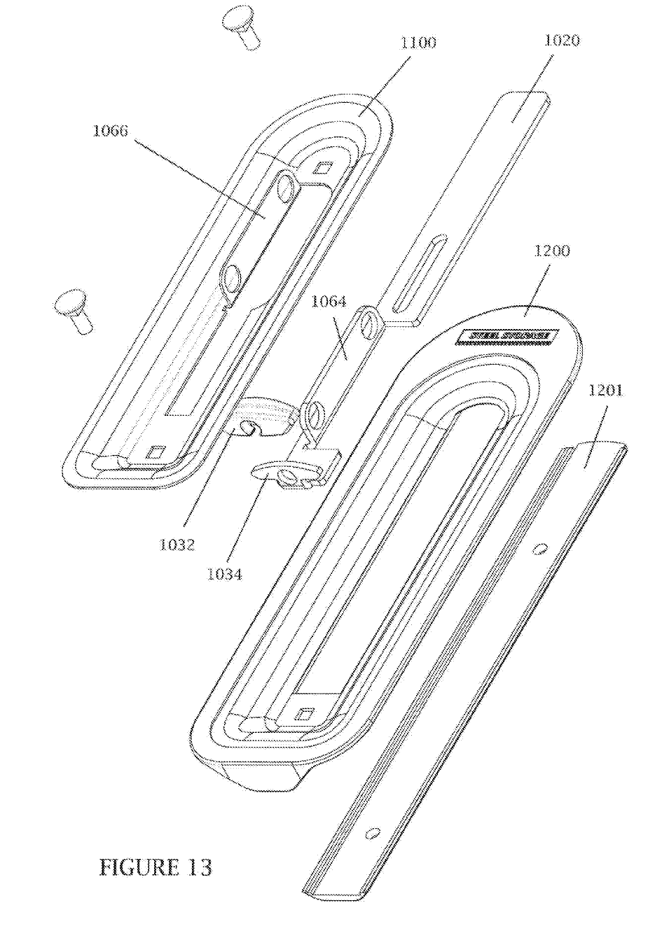

In a first embodiment, there is provided a door latch assembly 1000 suitable for being mounted on a roller door 2000 having a corrugated outer surface of ridges 2010 and grooves 2020, to form a roller door assembly 3000. The door latch assembly 1000 comprises a latching plate 1100, a latch tongue 1020 and a non-metallic mounting plate 1200. The non-metallic mounting plate 1200 is positionable within a groove 2020 of the roller door 2000, and adapted to provide a mounting for the latching member 1100. In this regard, it is configured and dimensioned for being received substantially within a groove 2020 of a corrugated roller door 2000, as shown in FIG. 11. The non-metallic mounting plate 1200 is preferably composed of plastic or rubber. The plastics is preferably UV resistant so it can be used outdoors.

The non-metallic mounting plate 1200 has a recess 1210 that is configured for receiving and locating at least part of the latching plate 1100, to provide a mounting for the latching plate 1100 so that the latching plate 1100 is also substantially received within the groove 2020 of the roller door 2000.

The mounting plate 1200 further comprises contact formations 1220 that are configured and dimensioned for locating within a groove 2020 of the roller door 2000. Other embodiments, for example shown in FIG. 9, have contact formations in the form of ribs 1220 that allow air to circulate behind the non-metallic mounting plate 1200 to ensure that moisture or water is retained or captured. It is envisaged that in use, a plurality of non-metallic mounting plate 1200 may be provided for use with various roller doors 2000, each of which can have different groove profiles.

The non-metallic mounting plate 1200 includes an attachable (or integral) latch tongue mounting plate 1201 that separates the latch tongue 1020 from the roller door 2000. In this way the latching plate 1100 and latch tongue 1020 are not in contact with the roller door 2000 and thereby avoid corrosion issues.

The latching plate 1100 has one or more slots or apertures including slot 1012 through which a handle 1032 extends from the latch tongue 1020. There are other apertures for the placement of fasteners 1042 to secure the latching plate 1100 and latch tongue 1020 to the non-metallic mounting plate 1200 and roller door 2000.

The latch tongue 1020 is slidable between an extended position and a retracted position. It has a handle 1032, extending via a neck 1034 from the latch tongue 1020 through a slot 1012 in the mounting plate 1010. The latch tongue 1020 is configured for allowing a user to move the latch tongue 1020 between its extended and retracted positions by manual manipulation.

In the context of this specification, the term “handle” is defined as being any formation that is capable of being operated on or manipulated manually by a user, for example such as a pushable buffer formation, and does not necessarily need to be of a shape or configuration that may be held in a user's hand. The latching plate 1 100 further comprises a locking arrangement 1060 for locking the latch tongue 1020 in its extended position. In a preferred embodiment it is envisaged that it may be possible for the latch tongue 1020 to also be locked in its retracted position.

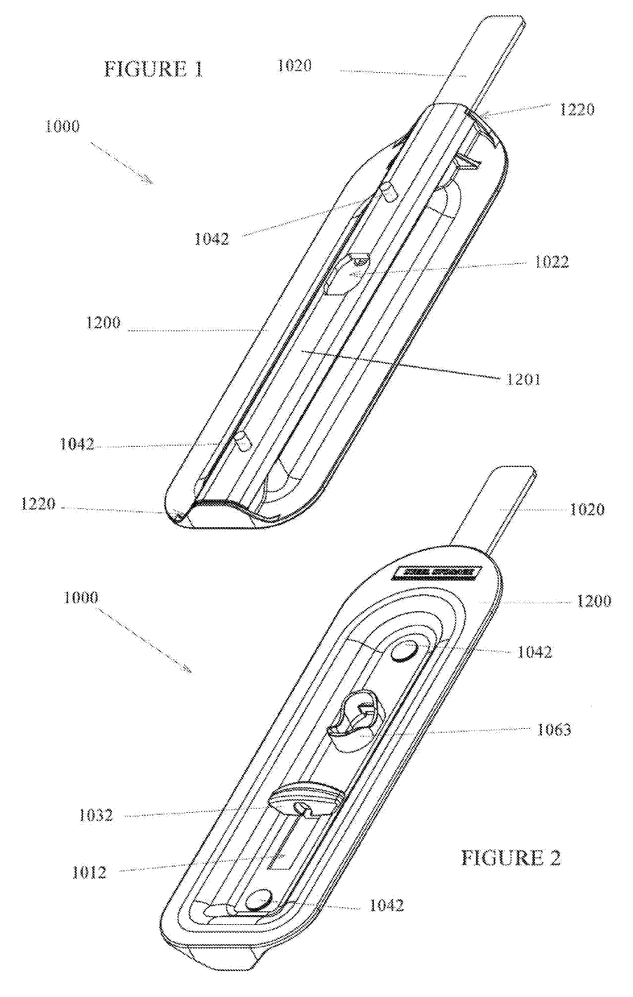

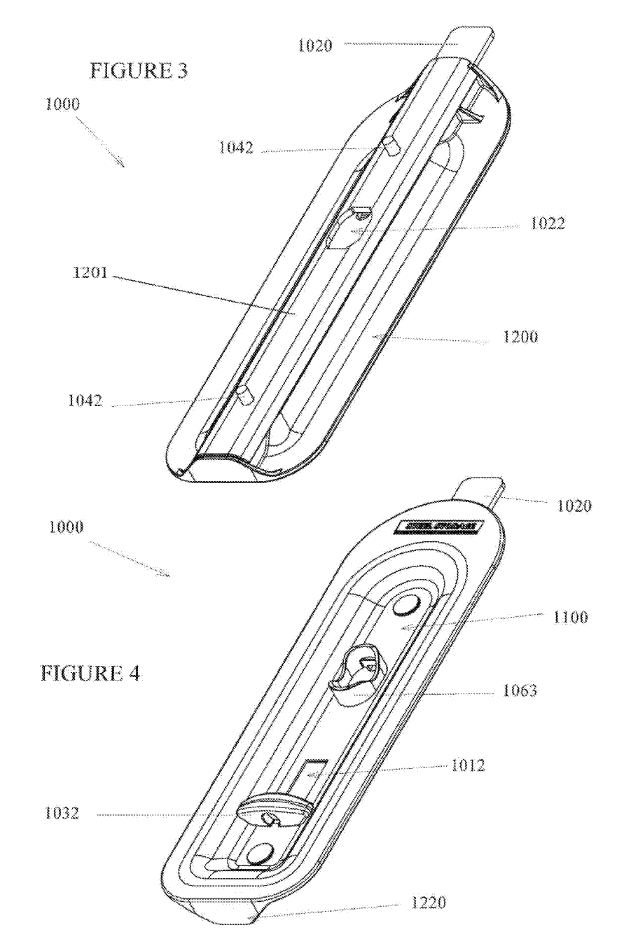

In FIGS. 1-4, an embodiment for use with a spring loaded lock barrel (not shown) is shown.

The lock barrel is typically movable between a locked position and an unlocked position, and is biased to its locked position. When in a locked position, only an unlocking operation using a key can cause it to be released to move to its unlocked position. Such lock barrels are known in the art, and an explanation of the detailed features of the lock barrel is considered as being beyond the scope of this specification.

The lock barrel is engageable with a lock engaging formation, embodied in FIGS. 1-4 by a shroud 1063 on the latching plate 1100. It will be appreciated that a wide variety of shapes and configurations are possible for the lock engaging formations.

When the lock barrel is pushed towards the latch tongue 1020 against its bias, a catch (not shown) holds it in place. The catch can only be released by means of a key used on the lock barrel.

When the latch tongue 1020 is in its extended position, the lock barrel will be aligned with a latch aperture 1022 in the latch tongue 1020. It is envisaged that the latch aperture 1022 could alternatively be a recess (not shown). When the lock barrel is moved to its locked position, it will extend through the latch aperture 1022, thereby locking the latch tongue 1020 in its extended position.

In order to move the latch tongue 1020 to its retracted position again, the lock barrel will require operation of a key to move it to its unlocked position thereby retracting the locking members of the lock and allow the lock to be removed.

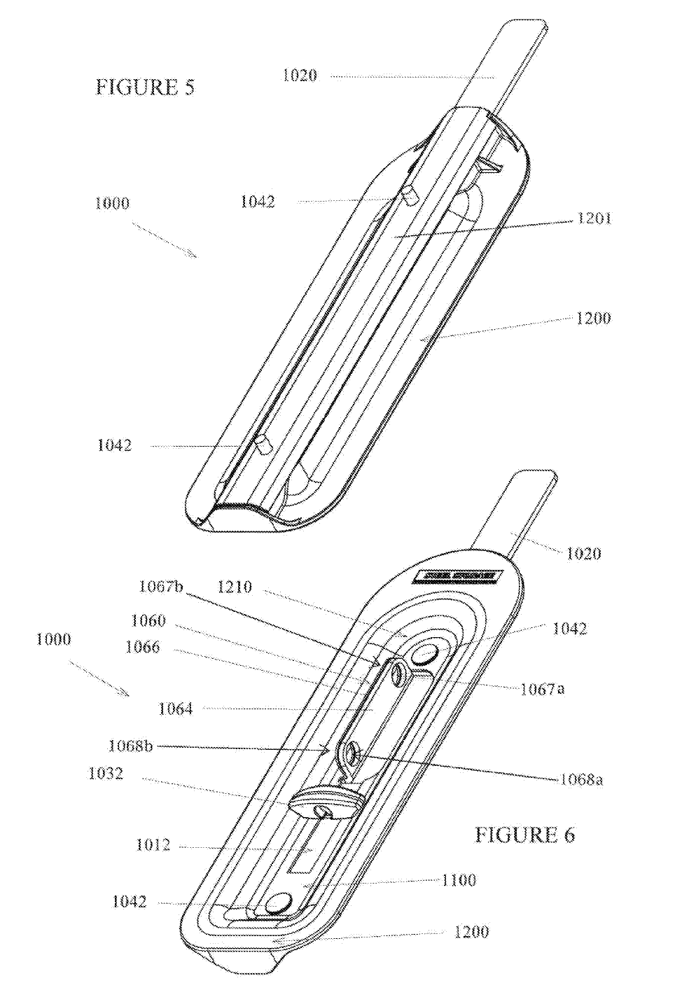

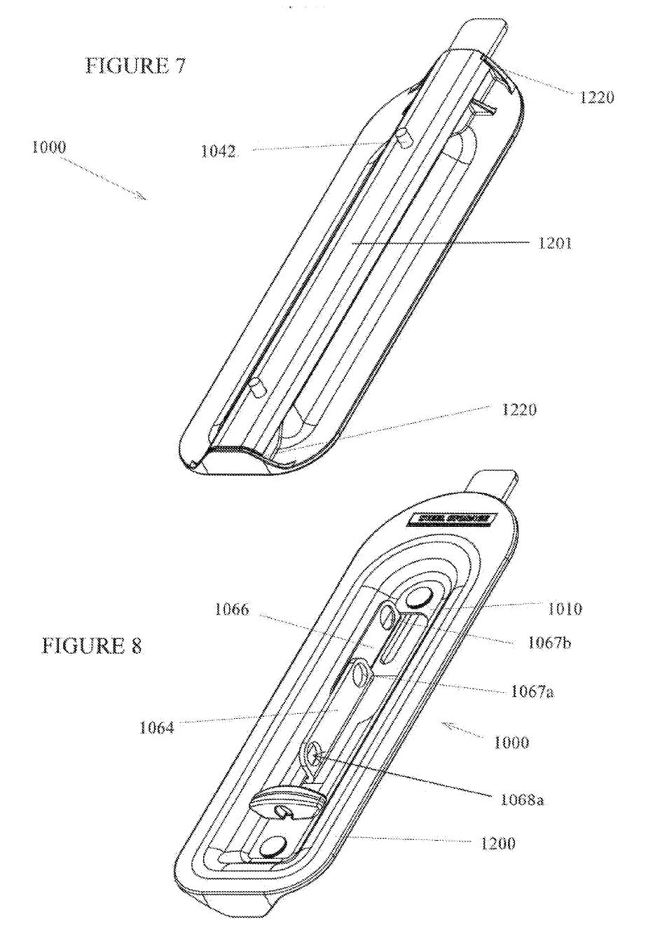

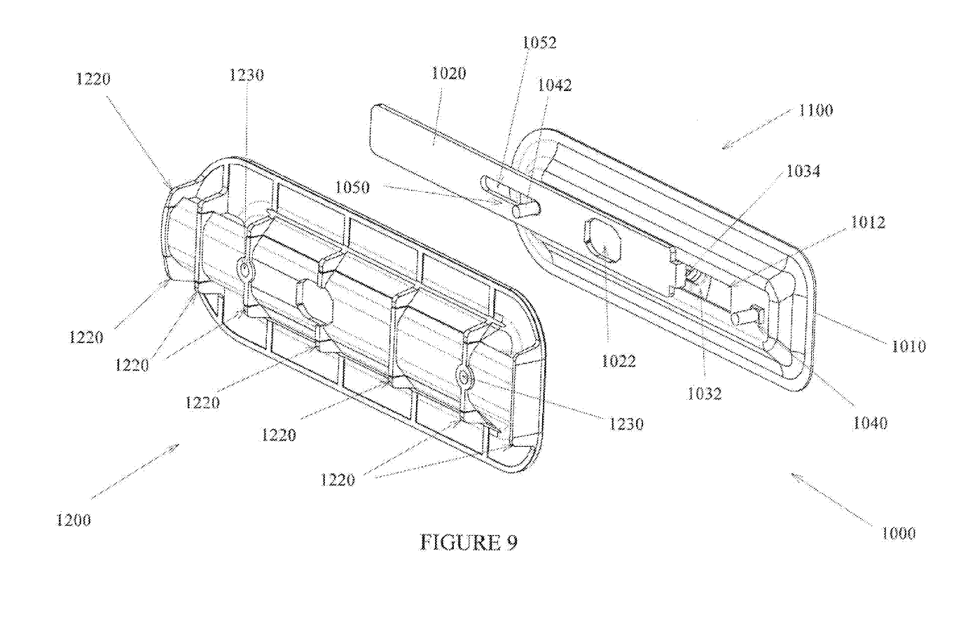

The embodiment shown in FIGS. 5-8 is for use with a padlock (not shown). In this embodiment, the locking arrangement 1060 comprises a first locking formation shown as a first latch plate 1064 securely coupled to and extending from the latch tongue 1020, and a complementary configured second locking formation shown as a second latch plate 1066 secured to and extending from the latching plate 1100 alongside the slot 1012. Both the first latch plate 1064 and second latch plate 1066 comprise similarly shaped locking apertures 1067a and 1067b that when overlapping allow a padlock to pass through them and lock them together.

The first latch plate 1064 extends through the slot 1012 in the latching plate 1100 from the latch tongue 1020, so that when the latch tongue 1020 is in its extended position, the locking apertures 1067a and 1067b are in alignment, permitting the insertion of a padlock through them. In this way, the latch tongue 1020 may be locked in its extended position.

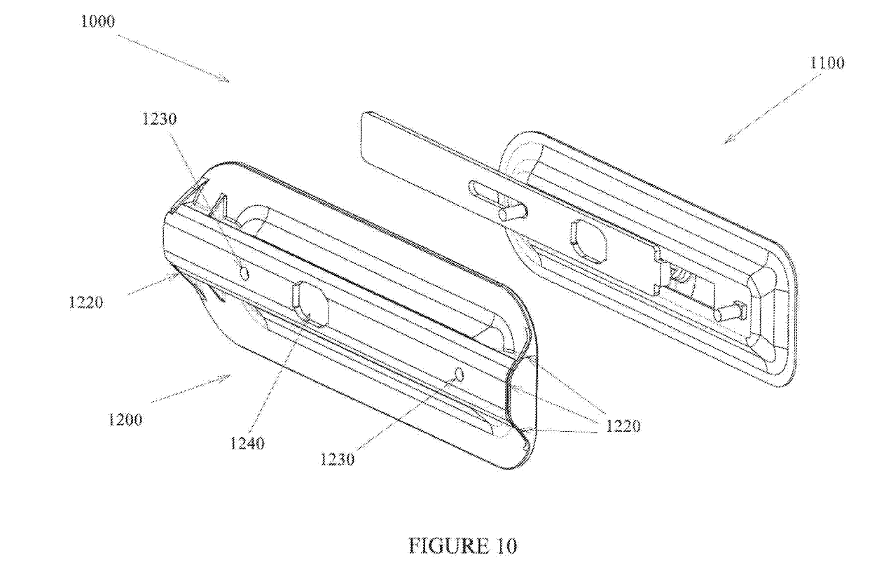

As shown in FIGS. 9 and 10, the latching member comprises at least one securing arrangement 1040 for securing the door latch assembly 1000 to the roller door 2000. It is envisaged that in a preferred embodiment as shown in the Figures, the securing arrangement 1040 comprises fastener 1042 that secure both the latching plate 1100 and the non-metallic mounting plate 1200 to the roller door 2000. In the embodiments shown in the Figures, the securing arrangement 1040 acts to secure the door latch assembly to the roller door at a location substantially intermediate the width of the groove (shown as reference numeral W in FIG. 11), and preferably in the middle of the width W of the groove.

In the embodiments shown in FIGS. 9 and 10, the securing formations 1042 extend through securing holes 1230 in the non-metallic mounting plate 1200.

It is envisaged that by securing the door latch assembly 1000 close to the center of the width W of the groove 2020 of the roller door, this will allow for adjacent ridges to break contact to a minor degree when the roller door is rolled up, thereby allowing for increased flexibility of the roller door 2000. In other words, the secured door latch assembly does not create a large, rigid, inflexible region within the roller door that prevents it from being rolled up.

In addition, the use of resilient material for the door engaging formation will assist in allowing for more flexibility of the roller door 2000 as it rolls up.

The latching plate 1100 is configured for retaining and guiding sliding movement of the latch tongue 1020 by means of a guiding arrangement 1050, which is shown in FIG. 10 as a pin in slot arrangement, wherein the securing formations 1042 are used as the pin, and a slot 1052 is provided in the latch tongue 1020.

In one embodiment shown in FIGS. 9 and 10, the guiding arrangement 1050 comprises a projection, in the form of a pin 1042, movable in a slot 1052. In the embodiments shown in FIGS. 9 and 10, the pin 1042 also acts as a securing formation used for securing the latching plate and non-metallic mounting plate 1200 to the roller door 2000, although this need not necessarily be the case. It is envisaged that while the projection is shown as a nut and bolt arrangement in the Figures, it can be any form of fastener (not shown), such as a rivet, screws, or the like.

It will be appreciated that a wide variety of configurations of handle members are possible, and need not be in the form of a handle. Instead they could be in the form of a wide variety of manual manipulation members.

The handle 1032 is an oversized handle to provide easier grip and help with sliding the latch tongue 1020.

The door latch assembly 1000 can also have a secondary locking arrangement that allows another lock to be placed and prevent movement of the latch tongue 1020. This feature is useful in the circumstances that a landlord can prevent access to an area such as a tenant's storage bay where there is a disagreement or non-payment of rent.

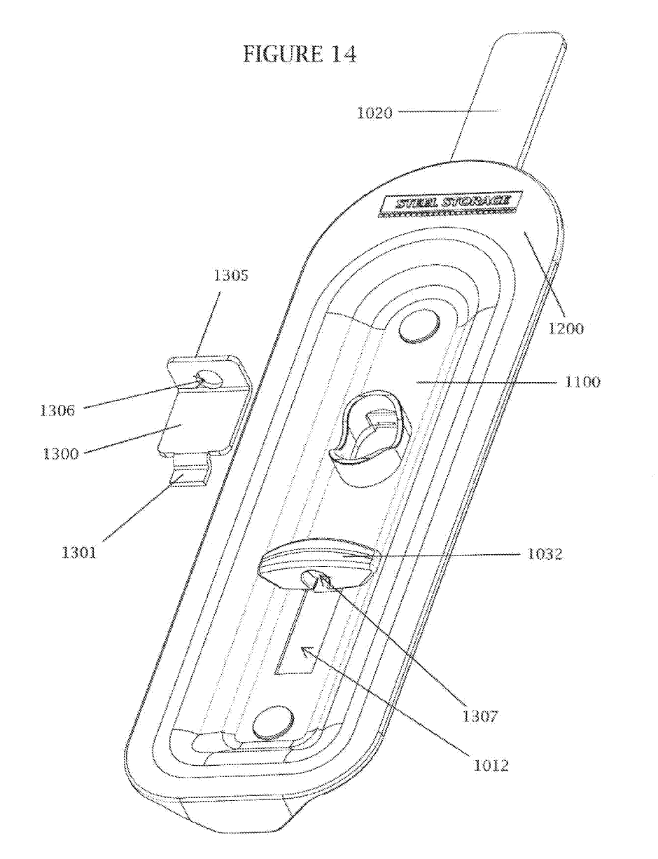

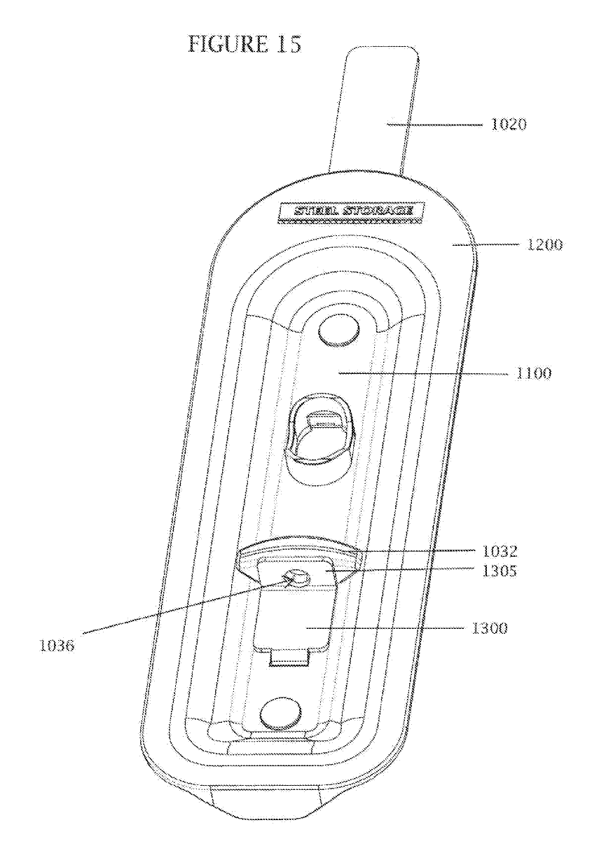

With reference to the embodiment shown in FIGS. 1 to 4, a secondary locking arrangement is shown in FIGS. 14 and 15 where an insert 1300 is positioned and retained within slot 1012 when the latch tongue 1020 is in the extended position. The insert 1300 has a retaining flange 1301 that can be placed beneath the latching plate 1100. The insert 1300 has a locking flange 1305 extending substantially upright. The locking flange 1305 has an aperture 1306 which when the insert 1300 is in an operative position, is aligned with the aperture 1307 in the handle 1032. When the apertures 1306 and 1307 are substantially aligned then a padlock or the like can be inserted and lock the latch tongue 1020 in position.

With reference to the embodiment shown in FIGS. 5 to 8, the first latch plate 1064 and the second latch plate 1066 each have a second aperture 1068a, 1068b respectively that when aligned allow a padlock or the like to pass there-through and lock the plates 1064, 1066 together and prevent the movement of the latch tongue 1020. The apertures 1068ab are aligned when apertures 1067 are aligned and the latch tongue 1020 is in the extended position.

It is envisaged that products according to the invention may be sold as a kit set, including a latching member 1100 as described above, and one or more non-metallic mounting plate 1200. Each of the non-metallic mounting plate 1200 will be configured and dimensioned for being received in and engaging with grooves 2020 of a roller door 2000 having alternative different profiles to each other. However, each of the non-metallic mounting plate 1200 will also be configured to be engageable with the same latching plate 1100. In this way, a single latching plate 1100 can be provided that may be used with different roller door profiles, thereby saving on duplication of tooling, reduction of stockholding.

In order to install the door latch assembly 1000, it is envisaged that suitably spaced and sized holes will be provided in the surface of the groove of a roller door 2000, for receiving the securing formation 1042. The holes will be spaced toward the center of the width of the groove 2020. The non-metallic mounting plate 1200 will be located within the groove 2020 and the latching plate 1100 will be located within the recess 1210 in the non-metallic mounting plate 1200. The securing formations will then be inserted through the latching plate 1010, the non-metallic mounting plate 1200 and the roller door 2000, and secured in that position, to thereby secure the door latch assembly 1000 within the groove of the roller door 2000.

It will be appreciated that the latching member 1 100 and non-metallic mounting plate 1200 can be inverted and used in a similar fashion in an inverted position. In this way the same door latch assembly can be used for left hand or right hand positions by inverting the orientation of the assembly.

Advantages

The advantages of the preferred embodiment include the ability to use a non-metallic mounting plate to mount the latching plate and tongue and thereby prevent surface to surface contact of the metal parts and prevent corrosion and its consequent issues.

A further advantage is that the non-metallic mounting plate provides an aesthetic pleasing latch arrangement. The use of the non-metallic mounting plate also avoids issues were the roller door surface may need to be repainted or touched up due to problems associated with installation of the latch assembly. Another advantage is that the non-metallic mounting plate is recessed allowing the latching plate to be positioned therein and avoid it being projected too far out and cause a possible safety issue.

A further advantage of the non-metallic mounting plate of the preferred embodiment is that it does not have any sharp edges which could cause injury to a person or damage to goods.

Variations

It will of course be realized that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

For the purpose of this specification, where method steps are described in sequence, the sequence does not necessarily mean that the steps are to be chronologically ordered in that sequence, unless there is no other logical manner of interpreting the sequence.

For the purposes of this specification, the term “plastic” shall be construed to mean a general term for a wide range of synthetic or semisynthetic polymerization products, and generally consisting of a hydrocarbon-based polymer.

As used herein the term “and/or” means “and” or “or”, or both.

As used herein “(s)” following a noun means the plural and/or singular forms of the noun.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

The disclosures and the descriptions herein are purely illustrative and are not intended to be in any sense limiting.

What is claimed is:

1. A door latch assembly for a roller door, the roller door having a corrugated surface of ridges and grooves; the door latch assembly including:
a non-metal mounting means attachable to the roller door;
a latching member locatable substantially within the mounting means; and
a latch tongue operatively retained by the mounting means and movable between a retracted position and an extended position for engagement with a door jamb, wherein the latch tongue has at least one protruding portion,
wherein the assembled door latch assembly has the latching member located substantially therein and the at least one protrusion of the latch tongue extends outwardly through the mounting means and the latching member to provide access to the latch tongue, and wherein the non-metal mounting means is attached to the roller door when the assembled door latch assembly is in use.

2. The door latch assembly of claim 1, wherein the mounting means is spaced from the roller door surface to allow the circulation of air to dry the surface.

3. The door latch assembly of claim 1, wherein the mounting means is made of UV stabilized plastics.

4. The door latch assembly of claim 1, wherein the mounting means is attached substantially within the groove of the corrugations of the roller door.

5. The door latch assembly of claim 1, wherein the mounting means includes a mounting plate and latching tongue backing plate.

6. The door latch assembly of claim 1, wherein the mounting means includes a mounting plate having a recess to accommodate the latching member.

7. The door latch assembly of claim 1, wherein the at least one protrusion forms a handle that can be used by a person to move the latching tongue.

8. The door latch assembly of claim 1, wherein the at least one protrusion can form a handle and a locking configuration.

9. The door latch assembly of claim 1, wherein the latching member comprises at least one retaining arrangement for retaining the latching member to the latch tongue.

10. The door latch assembly of claim 1, wherein the latching member comprises a locking arrangement configured for locking the latch tongue in its extended position.

11. The door latch assembly of claim 10, wherein the locking arrangement comprises a first locking formation coupled to the latch tongue, and a complementarily configured second locking formation securely associated with the latching member, the first locking formation and the second locking formation being complementarily configured to be locked together by a padlock when the latch tongue is in one position selected from its extended position and its retracted position.

12. The door latch assembly of claim 11, wherein the first locking formation and the second locking formation each comprise apertures that align when the latch tongue is in its extended position.

13. The door latch assembly of claim 1, wherein the locking arrangement comprises lock engaging formations configured for engaging and locating a lock barrel.

14. The door latch assembly of claim 13, wherein the lock barrel is movable between a locked position and an unlocked position.

15. The door latch assembly of claim 1, wherein the door latch assembly also includes an over-locking or secondary locking arrangement.

16. The door latch assembly of claim 15, wherein the secondary locking arrangement includes a second set of overlapping apertures associated with the latching member and the latch tongue where a separate padlock type lock can be used to the door latch assembly in the latch tongue's extended position.

17. The door latch assembly of claim 15, wherein the secondary locking arrangement includes an insert positionable within the latching member and serving to prevent retraction of the latch tongue.

18. The door latch assembly of claim 1, wherein the non-metal mounting means have different sizes to substantially fit within corresponding sized recesses in different corrugations while all able to accommodate the same latching member.

19. A system for a door latch assembly for a roller door, comprising:
a non-metal mounting means selected from a plurality of different sized non-metal mounting means where each fits substantially within a groove of a particular corrugated profile;
a latching member positionable within the non-metal mounting means; and
a securing arrangement for securing the latching member and latch tongue substantially within the groove of the roller door.

20. A method of installing a door latch assembly on a roller door having a corrugated profile of grooves and ridges, the method comprising the steps of:
selecting a non-metal mounting means from a plurality of non-metal mounting means having alternative profiles for engaging roller doors of varying profiles, the selected non-metal mounting means having a profile adapted for snug engagement substantially within a groove of the roller door to which the door latch assembly is to be installed;
locating a latching member into snug abutment with the selected non-metal mounting means; and
securing the latching member and latch tongue substantially within the groove of the roller door.

21. A roller door assembly comprising:
a corrugated roller door having a series of alternating grooves and ridges on at least one major face; and
a door latch assembly mounted substantially within a groove of the roller door, wherein the door latch assembly includes:
a non-metal mounting means attached to the roller door;
a latching member locatable substantially within the mounting means; and
a latch tongue operatively retained by the mounting means and movable between a retracted position and an extended position for engagement with a door jamb, wherein the latch tongue has at least one protruding portion, and
wherein the assembled door latch assembly has the latching member located substantially therein and the at least one protrusion of the latch tongue extends outwardly through the mounting means and the latching member to provide access to the latch tongue.
